(19) United States
(12) Patent Application Publication
(10) Pub. No.: US 2006/0127609 A1
(43) Pub. Date: Jun. 15, 2006

(54) Fire retardant molded artificial stone

(76) Inventors: Max Ivor Davies, Celebration, FL (US); Erik Omley, Orlando, FL (US)

Correspondence Address: B2 PATENT SERVICES, 406 ROSEMONT-RINGOES ROAD, STOCKTON, NJ, 08559, US

(21) Appl. No.: 11/011,261

(22) Filed: Dec. 14, 2004

(51) Int. Cl. B44F 7/00

(52) U.S. Cl. 428/15

(57) ABSTRACT

The present invention to a molded rock were stone made from a molding process with hydrate calcium sulfate and melamine formaldehyde resin which is further coated with a flame resistant polyester resin containing acrylic chips. Once cured, the substrate (calcium sulfate filled formaldehyde resin) provides excellent fire resistance. The polyester coating containing acrylic chips provides the look and texture of real stone. These molded imitation rocks find application as building materials for a variety of applications in residential and commercial buildings.

### FIELD OF INVENTION

This invention relates to a molded artificial stone that has good fire retardant properties and the look and feel of real stone. The stone products of this invention can be molded to many different sizes and shapes to imitate various types of naturally occurring rocks.

### BACKGROUND OF THE INVENTION

Naturally occurring stone and rock are difficult to use building materials and require the skills of a highly trained mason to obtain a reasonable result. The main difficulties with natural stone and rock are the wide variety of thicknesses and sizes that must be dealt with and the costs and time delays incurred as a result.

An artificial stone that can be molded to a relatively constant size and thickness makes the process of building much easier. The major drawbacks of molded products of this type have been their highly flammable nature and the toxic fumes they give off when burned. In addition, plastics and other synthetics used for common molding do not provide the texture and feel of natural stone or rock.

### DETAILED DESCRIPTION

This invention relates to an imitation rock or stone which provides a very high level of fire resistance with the look and feel of real stone and the benefit of having uniform thicknesses and/or sizes. This uniformity will provide for easier installation and reduced labor costs. The terms “rock” and “stone” are used interchangeably throughout this document. These imitation stones are made by a multi-step molding process. An outer shell provides the article with the look and feel of stone, while maintaining water and UV resistance. The inner core of the article provides the proper weight and durability and gives the solid rock-like attributes. One key requirement of this invention is that the outer coating must adhere well to the inner core, otherwise flaking and peeling (product failure) will occur.

For purposes of this application a molding process is defined as the addition of a mixture of a monomeric material (or mixture of materials) and curing agent to a hollow mold. Once cured, the substrate (or molded article) can be removed from the mold and trimmed to remove any excess material if necessary. The monomeric materials can be added to the mold by any traditional means used in the industry, but commonly are applied by pouring or spraying.

The outer shell is prepared from a fire retardant resin, filled with a particulate colorant. The particulate colorant can be any inert material such as sand, titanium dioxide (with or without pigment), micro beads, cellulose particles, acrylic chips, polyester chips or any other material that will provide the look of the stone being simulated. Depending on the type of rock being simulated, the color, size and distribution of the chips will vary. These chips can also be arranged in patterns to provide artful decor, not necessarily resembling a particular type of rock. In one embodiment of this invention the colored chips will be made of acrylic. In another embodiment the chips will be made of colored polyester resin.

The fire retardant resin provides water and UV resistance, a solid outer-shell, as well as being the clear support for the particulate colorant. Non-limiting examples of fire-retardant resins are, epoxy vinyl ester resin, isophthalic polyester resin, orthophthalic polyester resin, chlorendic, unsaturated and halogenated polyester resin. In one embodiment of this invention the fire retardant polyester is derived from phthalic anhydride (iso or ortho). In another embodiment the fire retardant resin is epoxy vinyl ester.

A curing agent is required to convert the liquid resin which is applied to the mold into a solid form. One skilled in the art would appreciate the wide variety of curing agents available on the market today, and would chose such an agent to match the resin system, time and temperature desired for the overall process. Additional materials can be added to the outer shell during the molding process to control the speed of the cure (cure inhibitors). This may be beneficial in controling the amount of excess heat generated during the exothermic polymerization step. These inhibitors can also be added to give longer working times, which will be tailored to the piece being molded and the processing equipment used. In one embodiment of this invention MEKP is used as the curing agent.

The thickness of the outer coating will be between 0.1 and 100 mm depending upon processing variables and the size of the imitation stone being molded. In one embodiment the thickness of the outer coating will be between 0.3 and 10 mm. In another embodiment the thickness will be between 0.3 and 2 mm.

The inner core is formed from a commercially available product known as Forton® MG. This system comprises hydrated calcium sulfate (Hydrocal FGR 95 sold by the United States Gypsum Company, 125 South Franklin St, Chicago, Ill. 606064678) in combination with a proprietary acrylic resin which cross-links with a dry resin known as Forton VF812 in the presence of a: melamine formaldehyde resin powder and a formaldehyde hardener.

To make the inner core more durable, fiberglass can be added to the hydrated calcium sulfate system. The fiberglass can be blended evenly into the core material before molding, or placed into the mold as a mat or layer.

For purposes of this invention imitation stone or rock is meant as any igneous, sedimentary or metamorphic rock, but also includes materials such as brick, cinderblock, or other masonry type decorative surfaces. One skilled in the art would recognize that addition of colorings, dies or pigments would be appropriate to afford the proper look.

One skilled in the art would recognize that this process could be used to prepare rocks or stones of any size or shape. Ideally the size and shape will be designed for ease of installation, packaging and handling. Additionally the application of these imitation stone or rock is meant to be used as building materials. Examples of these applications are, but not limited to, wall coverings, floorings, countertops, fireplaces or other structures in the home or commercial buildings.

Other additives can be included during the formulation of the substrate or the coating. These additives could be used to provide properties such as, but not limited to, increased adhesion (when applied to a wall or floor), surface luster, resistance to UV, mold release or easy cleaning.

Fire resistance (retardancy) is a desirable property for building materials in the home or in commercial buildings. As used in this application, retardancy is the ability of building materials to resist burning or generating toxic fumes (i.e. smoke). The standard test, ASTM E-84-03, was used to measure flames spread and smoke development. Acceptable results in this test are any material that will not ignite or will generate a smoke reading of less than 20% after five minutes in direct contact with a flame from a propane torch. In an embodiment of this invention, materials capable of smoke generation of less than 30% after 5 minutes and no propagation of the fire observed. In another embodiment of this invention, materials capable of smoke generation of less than 30% after 10 minutes with no propagation of the fire were seen.

The following examples are offered to better illustrate the invention, and are not meant to limit the scope or spirit in any way. All percents are on an as is basis unless otherwise noted.

### EXAMPLE 1

### Preparation of Imitation Rock

Preliminary—Creation of the Mold

A three-dimensional facsimile of the item to be manufactured is created. A mold s is created around the facsimile which has sufficient flexibility to enable removal of the final article once the molding process is complete. Silicone rubber or urethanes are the materials commonly used in the construction of the mold, although other materials could be used.

Preparation—Preparation of the Mold

The mold is thoroughly cleaned, dried and treated with release agent to ensure the casting does not stick to the mold.

The Outer Coating

The multi-colored acrylic chips (25 parts) is mixed with the orthophthalic Class 1 fire-retardant polyester resin (75 parts) and blended by hand until uniform. The temperature of this mixture is checked with a thermometer to ensure it is between 18 arid 24° C. A total of three parts of catalyst (MEKP) is added to the mixture and blended until uniform. Temperatures outside this range will require addition of more or less catalyst depending on desired length of cure.

This mixture is then sprayed into the mold to provide an even coating of between 1.0 and 1.8 mm in thickness. The mold is left to sit undisturbed until the surface was very tacky to the touch (approximately 1-2 hours). It is important not to allow the coating to completely dry.

The Inner Core

Forton MG (Contains: FBV-812 resin, FGR-95 Hydrated calcium sulfate, Dry melamine formaldehyde resin, Dry melamine formaldehyde hardener/MEPK) a molding mixture commonly available from many craft stores or the Internet, is prepared by the instructions provided. The resulting liquid is poured into the mold from above to form a thickness of between 0.76 and 2.0 mm such as to ensure all parts of the mold have been uniformly covered. The materials are allowed to dry until very tacky.

Another portion of the liquid Forton MG is prepared as per the instructions with the addition of 30% by weight finely chopped fiberglass. The fiberglass is blended into the Forton until uniform. This new mixture is then poured into the mold to obtain a thickness of between 5.0 and 10 mm. Again the materials are left to dry until very tacky.

The mold is now filled to the top with a freshly made portion of Forton MG. The article is allowed to completely dry and cure in the mold (typically overnight). Once full cure has been obtained, the article can be removed from the mold and any excess material trimmed from the sides.

### EXAMPLE 2

### Alternating Patterns

A mold was prepared as described in example 1. Using a series of masks, different chip\resin colors were sprayed into discrete sections of the mold to create a multi-colored finished surface. The coating was allowed to sit undisturbed until the sprayed surface became tacky to the touch. The remainder of the process is carried out as described above.

### EXAMPLE 3

### Reinforcing with a Fiberglass Met

The process as described in example 1 was repeated providing the Outer coating and the first layer of Forton MG to afford a uniform thickness of between 7.6 and 2.0 mm. A piece of fiberglass tape was cut to the approximate size of the mold and embedded into the cavity. The mold was then filled with the remainder of the Forton MG and the process completed as described in example 1.

### EXAMPLE 4

### Fire Retardancy Testing

The test apparatus consisted of two upright concrete blocks approximately 51 cm high, across the top of which was placed a sample panel approximately 61×76 cm. The sample panel was produced using the procedure of example 1.

A propane burner approximately 46 cm tall (available at any local hardware store) was placed beneath the sample panel, and equidistant from the supporting concrete blocks.

The propane burner was lighted and the flame adjusted so that it came into direct contact with the sample panel mounted above it. Observations were recorded each minute along with the amount of smoke generated (see Table 1 below). A temperature probe was attached to the extreme right-hand side of the sample panel and held in place between the panel and the concrete block on which it stood. The temperature at this extremity was recorded at approximately 60 second intervals and the results shown in table 2.

After ten minutes the flame was shut off and the sample panel examined. The blackened area had extended to approximately 60% of the surface of the sample. Approximately 20% of the surface had blistered. The panel was structurally intact with no apparent damage to the substrate. The surface, although blackened and blistered in several non-contiguous areas, was substantially intact and remained recognizable. The total amount of smoke emitted was minor. Flame was observed coming from the sample panel for only two intervals each of <2 seconds during the test.

TABLE 1
Fire retardant testing of retardant sample

| Time | | |
|---|---|---|
| (min) | Observation | Smoke |
| 1 | The center of the panel began to emit a small | Minimal |
| | amount of smoke and started to blacken. | |
| 2 | The smoke emission ceased. The blackened area | None |
| | extended contiguously approximately 7.6 cm from | |
| | the center. | |
| 3 | The center area blistered to a radius of | None |
| | approximately 3.8 cm. | |
| 4 | The blackened area extended approximately 17.8 | Minimal |
| | cm non-contiguously. | |
| 5 | A small amount of smoke was emitted for | Minimal |
| | approximately 15 seconds. | |
| 6 | The blackened area extended approximately 22.9 | None |
| | cm non-contiguously. Small amounts of blistering | |
| | were observed across this area. | |
| 7 | The blackened area had extended to approximately | None |
| | 30% of the surface of the sample. | |
| 8 | The blackened area had extended to approximately | None |
| | 40% of the surface of the sample. Approximately | |
| | 15% of the surface had blistered. The resin | |
| | coating at the center had disappeared. | |
| 9 | The blackened area had extended to approximately | None |
| | 50% of the surface of the sample. Approximately | |
| | 20% of the surface had blistered. | |

TABLE 2
Temperature during flame test

| Time | Temperature |
|---|---|
| (min) | (C. °) |
| 0 | 28 |
| 1 | 28 |
| 2 | 28 |
| 3 | 30 |
| 4 | 30 |
| 5 | 30 |
| 6 | 30.5 |
| 7 | 31 |
| 8 | 30 |
| 9 | 31 |

A comparative sample was prepared with the procedure as detailed in example 1; however the Forton VF 812 and melamine formaldehyde resin was replaced with a castable polyurethane. A gelcoat was used in place of the orthophthalic Class 1 fire-retardant polyester resin and the gelcoat was bonded to the polyurethane surface using fiberglass. The fire retardant test described in example 4 was measured on this sample and the results of the testing are shown in table 3.

TABLE 3
Fire retardant testing of non-retardant sample:

| Time | | |
|---|---|---|
| (min) | Observations | Smoke |
| 1 | Ignition was noted after 20 seconds with | some |
| | dripping flame | |
| 2 | Sample was totally engulfed exterior | Peak @ 56% |
| | temperature 140° C. | |
| 3 | | |
| 4 | | |
| 5 | | |
| 6 | | |
| 7 | | |
| 8 | | |
| 9 | Afterburn with max temperature of 252° C. | Slight 6% |

The above examples demonstrate the ability of the imitation rock of this invention to be able to withstand the spread of fire or generation of smoke and toxic fumes when exposed to a direct source of high temperature. Such fire resistance is highly desirable for construction of commercial and residential dwellings to afford the occupants time to escape in the event of a fire and to meet with building codes.

1) An imitation rock comprising an inner core and an outer shell, in which the inner core is made of Forton MG and the outer shell contains a particulate colorant and a fire retardant resin, wherein said inner core and outer shell have a high degree of fire resistance and the look and feel of a natural rock.

2) The imitation rock of claim 1, wherein the Forton MG is reinforced with fiberglass.

3) The imitation rock of claim 1, wherein the look and feel of the natural rock is chosen from the group consisting of igneous, sedimentary, metamorphic, brick and cinderblock.

4) The imitation rock of claim 1 wherein the outer shell is made of fire resistant polyester.

5) The outer shell of claim 4, wherein the polyester is chosen from the group consisting of orthophthalic polyester, isophthalic polyester and epoxy vinyl polyester.

6) The imitation rock of claim 1, wherein the particulate colorant are acrylic chips or polyester chips.

7) The imitation rock of claim 1, wherein the outer shell is between 0.1 and 100 mm in thickness.

8) The imitation rock of claim 1, wherein the outer shell is between 0.3 and 10 mm in thickness.

9) The imitation rock of claim 1, wherein the outer shell is between 0.3 and 2 mm in thickness.

10) The imitation rock of claim 1, wherein the fire resistance is greater than 5 minutes when contacted with the flame from a propane torch.

11) The imitation rock of claim 1, wherein the fire resistance is greater than 10 minutes when contacted with the flame from a propane torch.

12) The use of the imitation rock of claim 1 as a fire retardant barrier in a home or commercial building.

13) An imitation rock comprising an inner core and an outer shell, in which the inner core is made of Forton MG and the outer shell contains a colored acrylic particulate and a fire retardant polyester resin derived from phthalic anhydride, wherein said inner core and outer shell are fire resistant for greater than 10 minutes when exposed to the direct flame of a propane torch and said imitation rock has a look and feel of a natural rock.
